(19) United States
(12) Patent Application Publication
(10) Pub. No.: US 2015/0035764 A1
(43) Pub. Date: Feb. 5, 2015

(54) DIGITIZER PEN

(71) Applicant: KABUSHIKI KAISHA TOSHIBA, Tokyo (JP)

(72) Inventors: Saori Michihata, Sagamihara-shi (JP); Isao Ohba, Tokyo (JP); Toshiya Takano, Sagamihara-shi (JP)

(73) Assignee: KABUSHIKI KAISHA TOSHIBA, Tokyo (JP)

(21) Appl. No.: 14/243,590

(22) Filed: Apr. 2, 2014

(30) Foreign Application Priority Data
Jul. 31, 2013 (JP) 2013-159259

(51) Int. Cl. G06F 3/0354; G06F 3/038; G06F 3/041

(52) U.S. Cl. CPC G06F 3/03545; G06F 3/0416; G06F 3/0383
USPC 345/173; 345/179

(57) ABSTRACT

According at least to one embodiment, a digitizer pen includes a resonant circuit, a first switcher, a measurement processor, and a transmission module. The resonant circuit includes a coil. The first switcher allows a core tip of a core of a plurality of cores to be exposed. The measurement processor measures pressure applied to the exposed core. The transmission module transmits the pressure applied to the exposed core to the measurement module.

### CROSS-REFERENCE TO RELATED APPLICATIONS

This application is based upon and claims the benefit of priority from Japanese Patent Application No. 2013-159259, filed Jul. 31, 2013, the entire contents of which are incorporated herein by reference.

### FIELD

Embodiments described herein relate generally to a digitizer pen.

### BACKGROUND

At present, digitizers are prevalent. A stylus pen conforming to the current digitizer comprises one type of core. A pen type (color, thickness, etc.) is switched on a user interface, and writing comfort is switched by extracting and inserting the core itself.

In the present stylus pen, although the writing comfort can be adjusted by switching the core, switching the core is troublesome. In addition, the core is small and thus may get lost. In recent years, there has been also a demand for detection of pen pressure.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a a structure showing an electronic apparatus of an embodiment.

FIG. 2 is a block diagram showing a system structure of the electronic apparatus of the embodiment.

FIG. 3 is a structure showing a stylus pen of the embodiment.

FIG. 4 illustrates structures showing the stylus pen and a digitizer.

FIG. 5A and FIG. 5B are diagrams showing shapes of a core.

FIG. 6 is a flowchart showing a procedure for drawing a path of a position of a core tip of the stylus pen on a touchscreen display.

### DETAILED DESCRIPTION

Various embodiments will be described hereinafter with reference to the accompanying drawings.

In general, according to one embodiment, a digitizer pen includes a resonant circuit, a first switcher, a measurement processor, and a transmission module. The resonant circuit comprises a coil. The first switcher is configured to allow a core tip of a core of a plurality of cores to be exposed. The measurement processor is configured to measure pressure applied to the exposed core. The transmission module is configured to transmit the pressure applied to the exposed core to the measurement module.

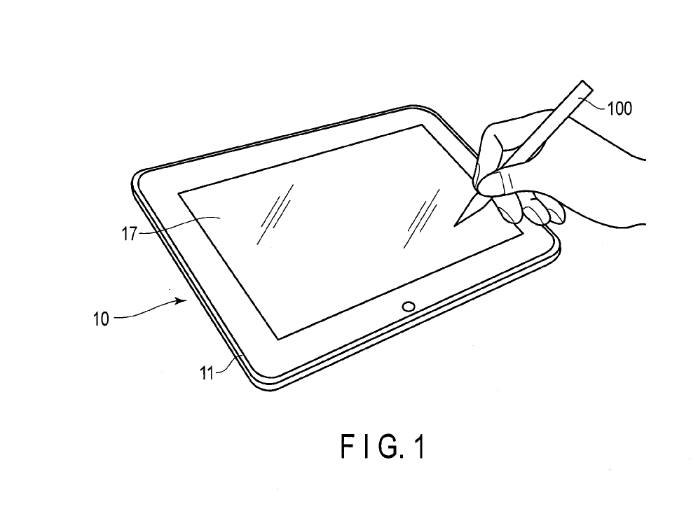

FIG. 1 is a perspective diagram showing an outer appearance of an electronic apparatus according to the embodiment. The electronic apparatus is, for example, a portable electronic apparatus wherein a handwritten character can be input by a pen or a finger. The electronic apparatus can be implemented as a tablet computer, a notebook-sized personal computer, a smartphone, a PDA, etc. In the following description, it is assumed that the electronic apparatus is implemented as a tablet computer 10. The tablet computer 10 is a portable electronic apparatus called a tablet or slate computer, and comprises a main body 11 and a touchscreen display 17 as shown in FIG. 1. The touchscreen display 17 is mounted to be superimposed on a top surface of the main body 11.

The main body 11 comprises a housing shaped like a thin box. In the touchscreen display 17, a flat panel display and a sensor (position detection device) configured to detect a position designated by a pen or a finger on a screen of the flat panel display are incorporated. The flat panel display may be, for example, a liquid crystal display (LCD). For example, an electrostatic capacity type touchpanel, an electromagnetic induction type digitizer, etc., can be used as the sensor (position detection device). The sensor is configured to detect a position which the pen or the finger touches or is close to. In the following description, it is assumed that both types of sensor, i.e., a digitizer and a touchpanel, are incorporated in the touchscreen display 17.

The digitizer and the touchpanel are each provided so as to cover the screen of the flat panel display. The touchscreen display 17 can detect not only a touch operation on the screen by the finger but a touch operation on the screen by a pen 100. The pen 100 may be, for example, an electromagnetic induction type pen. A user can perform a handwriting input operation on the touchscreen display 17 by using an external object (the pen 100 or the finger).

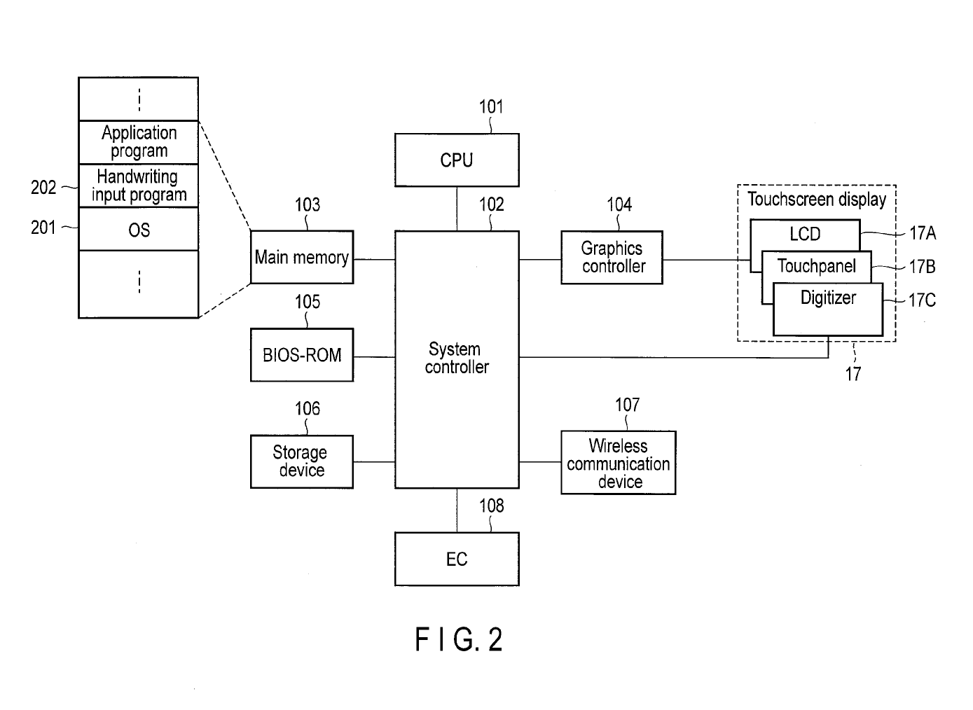

FIG. 2 shows a system structure of the tablet computer 10 of the embodiment.

As shown in FIG. 2, the tablet computer 10 comprises a CPU 101, a system controller 102, a main memory 103, a graphics controller 104, a BIOS-ROM 105, a storage device 106, a wireless communication device 107, an embedded controller (EC) 108, etc.

The CPU 101 is a processor configured to control operations of various modules in the tablet computer 10. The CPU 101 is configured to execute various programs loaded to the main memory 103 from the storage device 106. Programs executed by the CPU 101 comprise an operating system (OS) 201 and various application programs such as a handwriting input program 202. An application program 203 comprises, for example, a handwritten character recognition program, a browser program, an image editing program, a document preparation program.

By executing the handwriting input program 202, the CPU 101 achieves various functions related to preparation and edition of a note file (or a page), as well as a function of generating note data (page data [time-series information]) in accordance with the handwriting input operation by the pen 100 and a page editing function of editing a page included in the note file.

The CPU 101 is also configured to execute a basic input and output system (BIOS) stored in the BIOS-ROM 105. The BIOS is a program for hardware control.

The system controller 102 is a device configured to connect a local bus of the CPU 101 with various components. A memory controller configured to perform access control over the main memory 103 is also built in the system controller 102. The system controller 102 has also a function of communicating with the graphics controller 104 via a serial bus, etc.

The graphics controller 104 is a display controller configured to control an LCD 17A used as a display monitor of the tablet computer 10. A display signal generated by the graphics controller 104 is transmitted to the LCD 17A. The LCD 17A is configured to display a picture image based on the display signal. On the LCD 17A, a touchpanel 17B and a digitizer 17C are arranged as the position detection device. The touchpanel 17B is an electrostatic capacity type pointing device for input on a screen of the LCD 17A. A touch position on the screen which a finger is touched to, a motion of the touch position, etc., are detected by the touchpanel 17B. The digitizer 17C is an electromagnetic induction type pointing device for input on the screen of the LCD 17A. A touch position on the screen at which the pen 100 is touched, a motion of the touch position, etc., are detected by the digitizer 17C.

The wireless communication device 107 is a device configured to perform wireless communication such as wireless LAN or 3G mobile communication.

The EC 108 is a one-chip microcomputer comprising an embedded controller for power management. The EC 108 has a function of turning the tablet computer 10 on or off in accordance with a user's operation of a power button.

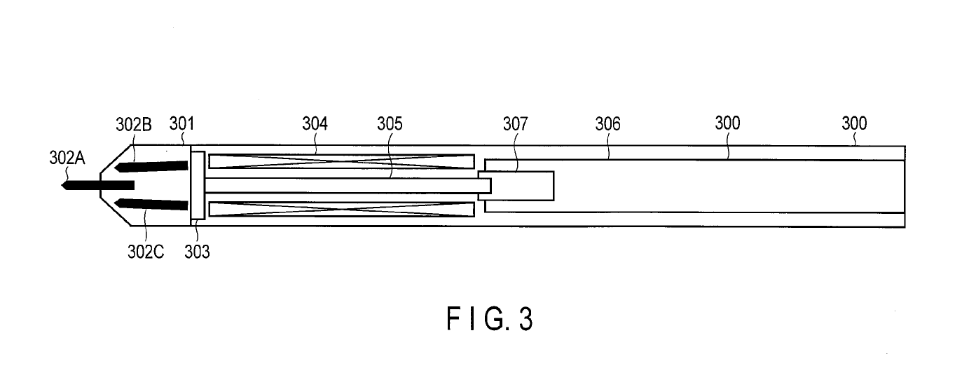

FIG. 3 shows a structure of a stylus pen as a digitizer pen according to the embodiment. At a tip of a main body 300 of the stylus pen 100, a rotary core switching mechanism (rotary feeding mechanism) 301 is provided. A plurality of cores 302A, 302B and 302C are built into the rotary core switching mechanism 301. If the rotary core switching mechanism 301 is rotated with respect to the main body 300, the plurality of cores projects from the rotary core switching mechanism 301 one by one as a drawing core. By rotating the rotary core switching mechanism 301, a core to be used can be switched.

A rear part of the rotary core switching mechanism 301 is connected to one end of a dummy core 305 via a pen pressure transmission mechanism 303. The other end of the dummy core 305 is connected to a pen pressure sensor 307 provided on a substrate 306. At the time of writing, pressure (pen pressure) applied to a core tip is transmitted to the pen pressure sensor via the rotary core switching mechanism 301, the pen pressure transmission mechanism 303 and the dummy core 305. A coil 304 is provided around the dummy core 305. The coil 304 is one of elements constituting a resonant circuit.

A plurality of cores can be installed by separating the cores into the dummy core 305 being in contact with the pen pressure sensor 307 and the other cores. A mechanism for transmitting pen pressure to the sensor 307 becomes necessary in accordance with pen pressure applied to a core. Thus, instead of the dummy core, a projection being in indirect contact with the sensor may be provided.

(Pen Type Selection)

In the above-described stylus pen, a plurality of cores can be switched. A method for switching the type (color, thickness, etc.) of line drawn on the LCD 17A in accordance with a selected core will be explained.

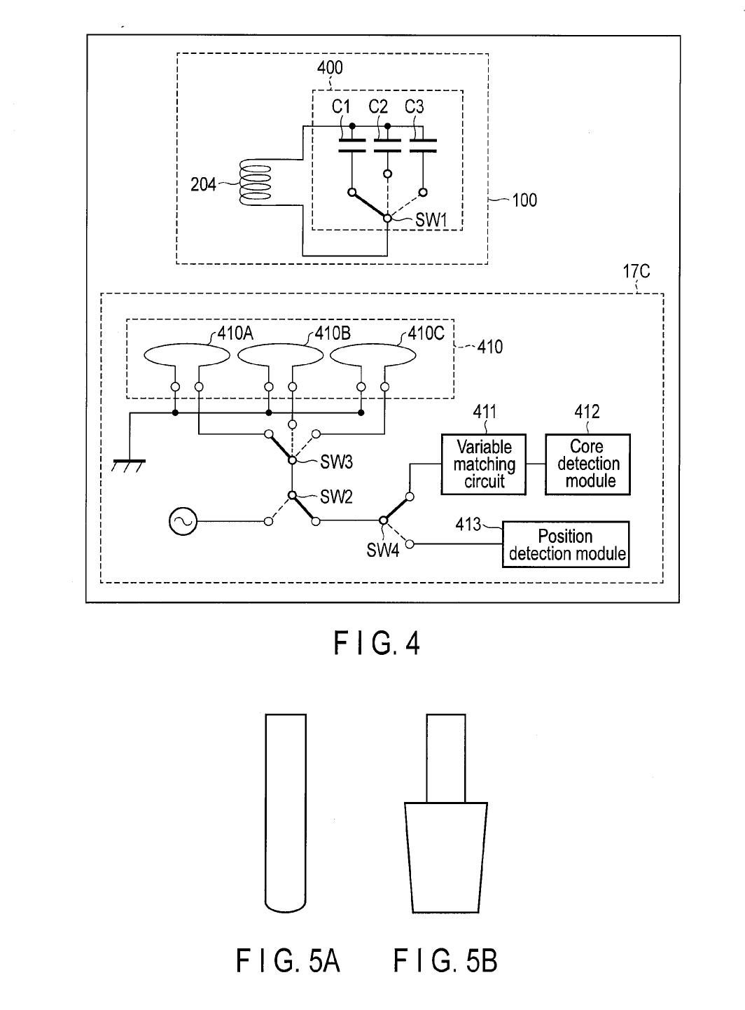

FIG. 4 shows the structures of the stylus pen 100 and the digitizer 17C.

The stylus pen 100 comprises a resonant frequency switching module 400. The resonant frequency switching module 400 is configured to switch a resonant frequency of the resonant circuit comprising the coil 304 in accordance with a core projecting from the rotary core switching mechanism 301.

The resonant frequency switching module 400 comprises a plurality of capacitors C1, C2 and C3, a switch SW1, etc. The capacitors C1, C2 and C3 differ from each other in capacitance. The switch SW1 is configured to switch a capacitor to be connected to the coil 304 in accordance with a core projecting from the rotary core switching mechanism 301. By switching the capacitor to be connected to the coil 304 in accordance with a core, the resonant frequency of the resonant circuit comprising the coil 304 can be switched.

The digitizer 17C comprises an antenna coil array 410, a transmission/reception changeover switch SW2, an antenna coil changeover switch SW3, a changeover switch SW4, a variable matching circuit 411, a core detection module 412, a position detection module 413, a current driver 414, etc.

The transmission/reception changeover switch SW2 is configured to switch connection of the coil array 410 between the current driver 414 and the changeover switch SW4 at every fixed time (T1, T2).

If the coil array 410 is connected to the current driver 414, alternating current is passed through an antenna coil in the antenna coil array 410 from the current driver 414, and energy is stored in the resonant circuit of the stylus pen. If the coil array 410 is connected to the changeover switch SW4, resonance current is passed through the coil 304 of the stylus pen 100, and energy is detected by an antenna coil.

The antenna coil array 410 comprises a plurality of antenna coils 410A, 410B and 410C. The antenna coil changeover switch SW3 is configured to switch an antenna coil to be connected to the variable matching circuit 411 or the position detection module 413 between the antenna coils 410A, 410B and 410C in turn.

An antenna coil which is closest to the stylus pen 100 receives highest amplitude, and a relatively weak signal is detected from an antenna coil adjacent thereto. Thus, a position of the stylus pen 100 can be calculated.

If a pen tip is brought close to a detection surface of the digitizer, the antenna coil array 410 is connected to the variable matching circuit 411 via the changeover switch SW4. The variable matching circuit 411 is configured to detect the resonant frequency of the resonant circuit in the stylus pen. The core detection module 412 is configured to detect a core projecting from the stylus pen based on the detected resonant frequency. The core detection module 412 is configured to notify the operating system 201 of core information corresponding to the detected resonant frequency. The operating system 201 is configured to notify the handwriting input program 202 of the core information. The handwriting input program 202 is configured to read pen type information (color, thickness, etc.) associated with the core information.

After the pen type information is notified, the antenna coil array 410 is connected to the position detection module 413 via the changeover switch SW4. The position detection module 413 is configured to detect a position of a core tip of the stylus pen 100 in accordance with output from a sensor module. The position detection module 413 is configured to notify the operating system 201 of positional information indicating the detected position. The operating system 201 is configured to notify the handwriting input program 202 of a detection result.

The handwriting input program 202 is configured to perform processing for drawing a path of the position on the LCD 17A based on the pen type information and the positional information.

For example, by comprising cores having different colors, the digitizer pen can be used instinctively as in common use of a pen where a color is selected for a pen and then writing is started.

It is also possible to make not only colors but shapes of cores imitate a ballpoint pen (FIG. 5A), a calligraphy brush, a highlighter (FIG. 5B), etc., and write in accordance with each core. In addition, it is also possible to draw with a core to one's liking by changing materials of cores and mounting a plurality of cores which differ from each other in writing comfort.

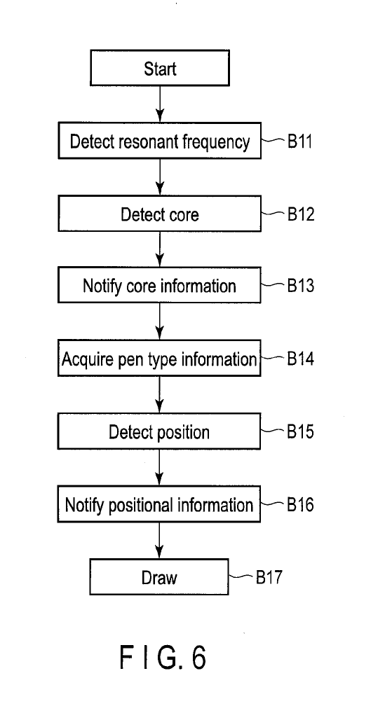

FIG. 6 is a flowchart showing a procedure for drawing a path of the position of the core tip of the stylus pen on the touchscreen display.

The variable matching circuit 411 is configured to detect the resonant frequency of the resonant circuit comprising the coil 304 (block B11). The core detection module 412 is configured to detect a core based on the detected resonant frequency (block B12). The core detection module 412 is configured to notify the handwriting input program 202 of the core information indicating the detected core via the operating system 201 (block B13). The handwriting input program 202 is configured to acquire the pen type information associated with the core information (block B14).

The position detection module 413 is configured to detect a position of the pen tip of the stylus pen 100 (block B15). The position detection module 413 is configured to notify the handwriting input program 202 of the positional information indicating the detected position via the operating system 201 (block B16). The handwriting input program 202 is configured to perform processing for drawing the path of the position of the core tip on the LCD 17A based on the pen type information and the positional information (block B17).

According to the stylus pen of the embodiment, there are provided the rotary core switching mechanism 301 which allows a core tip of one of a plurality of cores to be exposed, the pen pressure sensor 307 configured to measure pressure applied to a first core exposed from the rotary core switching mechanism 301, and the pen pressure transmission mechanism 303 and the dummy core 305 which are configured to transmit the pressure applied to the first core to the pen pressure sensor 307. Thus, the cores can be easily switched and can be prevented from getting lost.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A digitizer pen comprising:
a resonant circuit comprising a coil;
a first switcher configured to allow a core of a plurality of cores to be exposed;
a measurement processor configured to measure pressure applied to the exposed core; and
a transmitter configured to transmit the pressure applied to the exposed core to the measurement module.

2. The pen of claim 1, wherein the first switcher comprises a rotary feeding mechanism.

3. The pen of claim 1, further comprising a second switcher configured to switch a resonant frequency of the resonant circuit in accordance with the exposed core.

4. The pen of claim 3, wherein the second switcher is configured to switch a capacitor to be connected to the coil in accordance with the exposed core.

5. The pen of claim 4, wherein the second switcher comprises
a plurality of capacitors corresponding to the plurality of cores, the plurality of capacitors differing from each other in capacitance; and
a connecting module configured to connect a capacitor of the plurality of capacitors to the coil, the capacitor corresponding to the exposed core.

6. A system comprising a digitizer pen and an electronic apparatus,
the pen comprising
a resonant circuit comprising a coil,
a first switcher configured to allow a core of a plurality of cores to be exposed, and
a second switcher configured to switch a resonant frequency of the resonant circuit comprising the coil in accordance with the exposed core; and
the apparatus comprising
a plurality of coils,
a frequency detector configured to detect the resonant frequency of the resonant circuit in accordance with output from the plurality of coils,
a position detector configured to detect a position of the pen in accordance with the output from the plurality of cores, and
a drawing processor configured to cause a path of the detected position to be drawn on a display based on pen type information associated with information indicating the detected resonant frequency, and the detected position.

7. A drawing method using a digitizer pen comprising a resonant circuit comprising a plurality of coils, a first switcher configured to allow a core of a plurality of cores to be exposed, and a second switcher configured to switch a resonant frequency of the resonant circuit comprising the plurality of coils in accordance with the exposed core, the method comprising:
detecting the resonant frequency of the resonant circuit in accordance with output from the plurality of coils;
detecting a position of the pen in accordance with the output from the plurality of coils; and
causing a path of the detected position to be drawn on a display based on pen type information associated with information indicating the detected resonant frequency, and the detected position.
